(19) United States
(12) Patent Application Publication
(10) Pub. No.: US 2010/0302968 A1
(43) Pub. Date: Dec. 2, 2010

(54) COMMUNICATION ACCESS TECHNOLOGY MANAGEMENT

(75) Inventors: Guang Lu, Montreal (CA); Michelle Perras, Montreal (CA); Catherine M. Livet, Montreal (CA); Juan Carlos Zuniga, Montreal (CA); Shamim A. Rahman, Montreal (CA)

Correspondence Address: VOLPE AND KOENIG, P.C.;DEPT. ICC, UNITED PLAZA, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/790,115

(22) Filed: May 28, 2010

Related U.S. Application Data
(60) Provisional application No. 61/182,235, filed on May 29, 2009.
(60) Provisional application No. 61/187,594, filed on Jun. 16, 2009.

(51) Int. Cl. H04L 12/26

(52) U.S. Cl. 370/252

(57) ABSTRACT

A method and apparatus are disclosed for communication access technology management. A wireless transmit/receive unit (WTRU) may evaluate end-to-end connection performance by sending a connection ECHO message and receiving a connection ECHO response. The connection performance may be evaluated for a connection including multiple transmission paths, and for multiple connections. The WTRU may establish or modify a multihoming communication session with a mobility server using a plurality of connections. Each connection may be established using a different interface.

### CROSS REFERENCE TO RELATED APPLICATIONS

This application claims the benefit of U.S. provisional application No. 61/182,235 filed May 29, 2009 and U.S. provisional application No. 61/187,594 filed Jun. 16, 2009; which are incorporated by reference as if fully set forth herein.

### FIELD OF INVENTION

This application is related to wireless communications.

### BACKGROUND

A wireless transmit/receive unit (WTRU) may use inter-radio access technology (RAT) mobility to evaluate performance for a communication session performed using a first RAT, and to handover a communication session between heterogeneous networks. However, existing methods for evaluating performance are inaccurate, and existing handover methods are inefficient. Accordingly, a method and apparatus for communication access technology management would be advantageous.

### SUMMARY

A method and apparatus are disclosed for communication access technology management. A wireless transmit/receive unit (WTRU) may evaluate end-to-end connection performance by sending a connection ECHO message and receiving a connection ECHO response. The connection performance may be evaluated for a connection including multiple transmission paths, and for multiple connections. The WTRU may establish or modify a multihoming communication session with a mobility server using a plurality of connections. Each connection may be established using a different interface.

### BRIEF DESCRIPTION OF THE DRAWINGS

A more detailed understanding may be had from the following description, given by way of example in conjunction with the accompanying drawings wherein:

FIG. 1 shows a Long Term Evolution wireless communication network that includes an Evolved-Universal Terrestrial Radio Access Network;

FIG. 2 shows a block diagram of an example of a Long Term Evolution wireless communication network including a wireless transmit/receive unit, an evolved Node-B, and a Mobility Management Entity Serving Gateway;

FIG. 3 shows a diagram of an example of multi-radio access technology wireless communication;

FIG. 4 shows a diagram of an example of a method of communication session performance evaluation;

FIGS. 5A-5B show a diagram of an example of a wireless end-to-end performance measurement method for fallback;

FIGS. 6A-6B show a diagram of an example of a wireless end-to-end performance measurement method for standalone fallback;

FIGS. 7A-7B show a diagram of an example of a wireless end-to-end performance measurement method for standalone optimization;

FIGS. 8A-8B show a diagram of an example of a wireless end-to-end performance measurement method for load-balancing;

FIGS. 9A-9B show a diagram of an example of a wireless end-to-end performance measurement method for standalone load-balancing;

FIG. 10 shows a diagram of an example of a method of multihoming;

FIG. 11 shows a diagram of an example of a structure of a multihoming identifier;

FIGS. 12A-12B show a diagram of a method of a multihoming configuration optimized for reliability; and

FIGS. 13A-13B show a diagram of an example of a method of multihoming message distribution.

### DETAILED DESCRIPTION

When referred to hereafter, the terminology “wireless transmit/receive unit (WTRU)” includes but is not limited to a user equipment (UE), a mobile station (MS), an advanced mobile station (AMS), a Machine to Machine (M2M) equipment (M2ME), a fixed or mobile subscriber unit, a pager, a cellular telephone, a personal digital assistant (PDA), a computer, or any other type of device capable of operating in a wireless environment. When referred to hereafter, the terminology “base station” includes but is not limited to a Node-B, an advanced base station (ABS), a site controller, an access point (AP), or any other type of interfacing device capable of operating in a wireless environment. The terminology “WTRU” and “base station” are not mutually exclusive.

When referred to hereafter, the terminology “quality” or “signal quality” includes but is not limited to a measurement of the quality of a received signal. For example, Reference Signal Received Quality (RSRQ) in Long Term Evolution (LTE) or Common Pilot Channel (CPICH) Ratio of energy per modulating bit to the noise spectral density (Ec/No) in Universal Mobile Telecommunication System (UMTS). For simplicity, the quality of a signal received from a source may be referred to as the source's quality; for example the quality of a signal received from a WTRU may be referred to as the WTRU's quality. Similarly, the quality of a received signal that includes information may be referred to as the information's quality, for example the quality of a signal that includes an acknowledgment (ACK) may be referred to as the ACK's quality. When referred to herein, the terminology “received signal level” includes but is not limited to a measurement of power of a received signal; for example, Reference Signal Received Power (RSRP) in LTE or CPICH Received Signal Code Power (RSCP) in UMTS. When referred to herein, the terminology “connection” includes but is not limited to a link, a port, a wireline connection, a wireless connection, an IP address, a RAT, or any combination thereof.

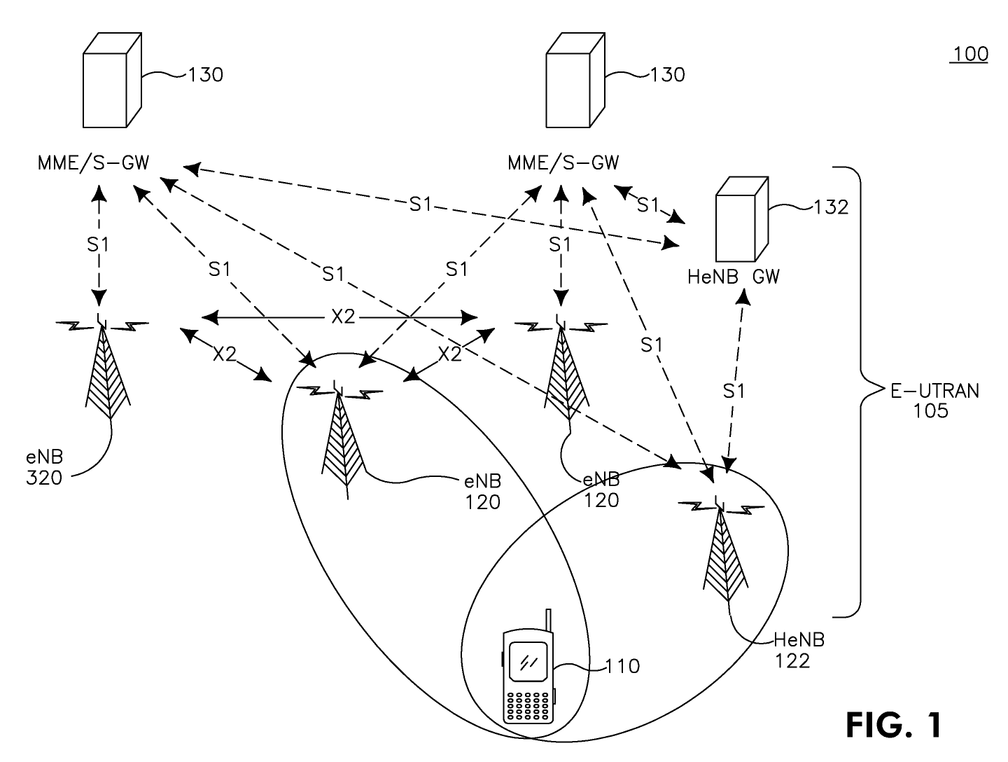

FIG. 1 shows a diagram of an example of a Long Term Evolution (LTE) wireless communication system/access network 100 that includes an Evolved-Universal Terrestrial Radio Access Network (E-UTRAN) 105 and a WTRU 110. The E-UTRAN 105 is shown as including several E-UTRAN Node-Bs (eNBs) 120, a Home eNB (HeNB) 122, and a HeNB Gateway (HeNB GW) 132. The WTRU 110 may be in communication with an eNB 120, the HeNB 122, or both. The eNBs 120 interface with each other using an X2 interface. Each of the eNBs 120 and the HeNB GW 132 interface with a Mobility Management Entity (MME)/Serving Gateway (S-GW) 130 through an S1 interface. The HeNB 122 may interface with the HeNB GW 132 through an S1 interface, with the MME/S-GW 130 through an S1 interface, or with both. Although a single WTRU 110, a single HeNB, and three eNBs 120 are shown in FIG. 1, it should be apparent that any combination of wireless and wired devices may be included in the wireless communication system/access network 100.

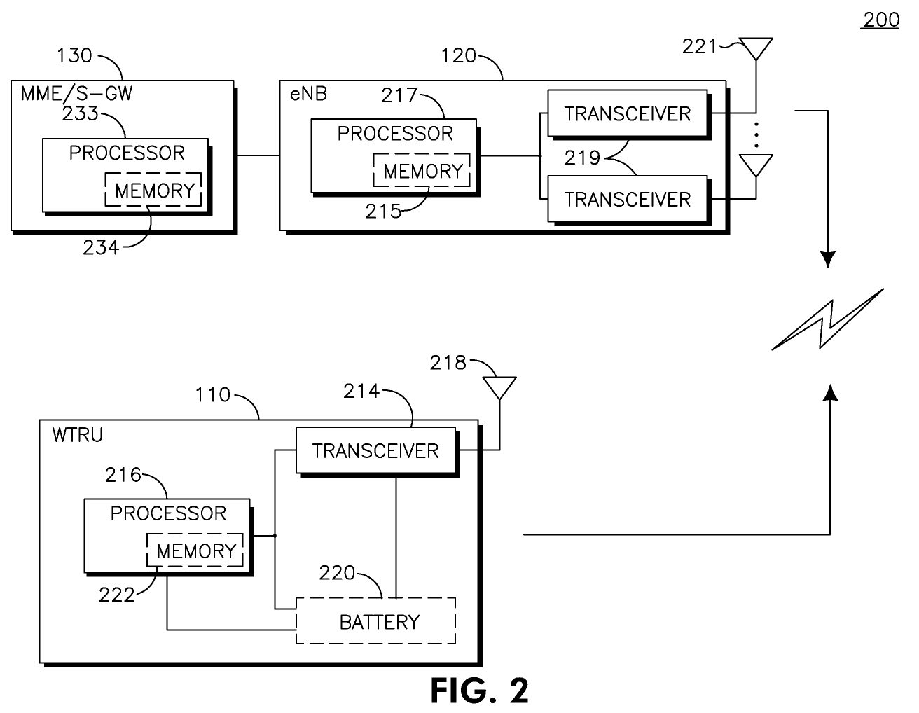

FIG. 2 is a block diagram of an example LTE wireless communication system 200 including the WTRU 110, the eNB 120, and the MME/S-GW 130. Although the eNB 120 and MME/S-GW 130 are shown for simplicity, it should be apparent that an example of a HeNB 122 and HeNB GW 132 may include substantially similar features. As shown in FIG. 2, the WTRU 110, the eNB 120 and the MME/S-GW 130 are configured to perform communication access technology management.

In addition to the components that may be found in a typical WTRU, the WTRU 110 includes a processor 216 with an optional linked memory 222, at least one transceiver 214, an optional battery 220, and an antenna 218. The processor 216 is configured to perform communication access technology management. The transceiver 214 is in communication with the processor 216 and the antenna 218 to facilitate the transmission and reception of wireless communications. In case a battery 220 is used in the WTRU 110, it powers the transceiver 214 and the processor 216.

In addition to the components that may be found in a typical eNB, the eNB 120 includes a processor 217 with an optional linked memory 215, transceivers 219, and antennas 221. The processor 217 is configured to perform communication access technology management. The transceivers 219 are in communication with the processor 217 and antennas 221 to facilitate the transmission and reception of wireless communications. The eNB 120 is connected to the Mobility Management Entity/Serving Gateway (MME/S-GW) 130 which includes a processor 233 with an optional linked memory 234.

The LTE network shown in FIGS. 1 and 2 is just one example of a particular communication network; other types of communication networks may be used without exceeding the scope of the present disclosure. For example, the network may be a Universal Mobile Telecommunication System (UMTS) network, a Global System for Mobile communication (GSM) network, or an 802.x network. When referred to hereafter, the terminology “Macro Cell” includes but is not limited to a base station, an E-UTRAN Node-B (eNB), or any other type of interfacing device capable of operating in a wireless environment. When referred to hereafter, the terminology “Home Node-B (HNB)” includes but is not limited to a base station, a Home evolved Node-B (HeNB), a femtocell, or any other type of interfacing device capable of operating in a Closed Subscriber Group wireless environment.

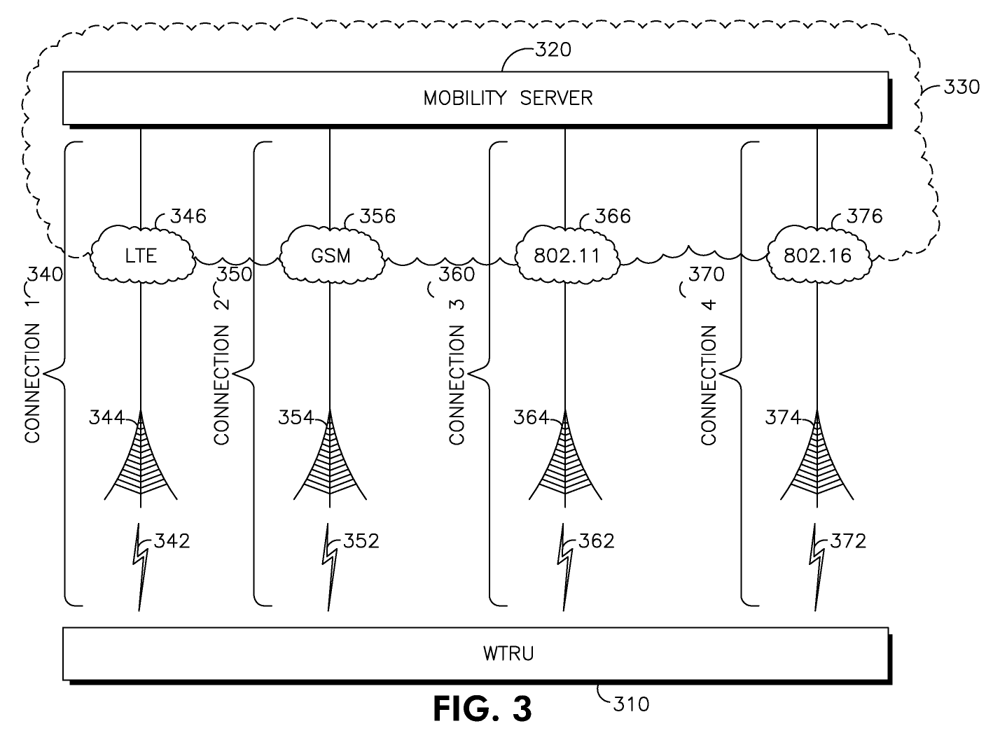

FIG. 3 shows a diagram of an example of multi-radio access technology (RAT) wireless communication. A WTRU 310 may perform a wireless communication session with a mobility server 320 over the internet 330 via one or more connections 340, 350, 360, 370. A connection may include a wireless link 342, 352, 362, 372 between the WTRU 310 and a base station 344, 354, 364, 374 connected to a RAT network 346, 356, 366, 376, such as LTE, GSM, 802.11x, or 802.16. Although LTE, GSM, 802.11x, and 802.16 are shown for simplicity, any access technology may be used. Although four (4) connections are shown for simplicity, any number of connections may be used. Each RAT network 346, 356, 366, 376 may communicate with the mobility server 320 via the internet 330. Although the mobility server 320 is shown as a part of the internet, the mobility server 330 may be included in any access network 346, 356, 366, 376.

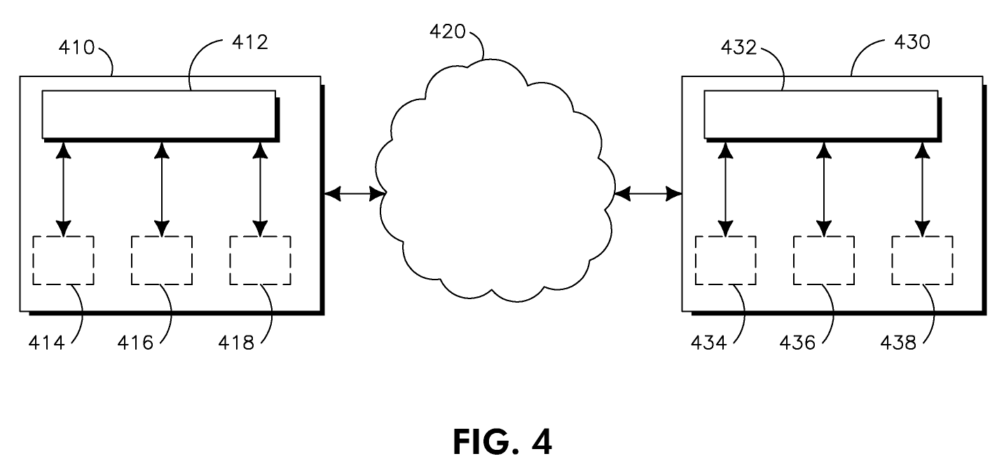

FIG. 4 shows an example method of communication session performance evaluation. Communication session performance evaluation may include measurement of the end-to-end performance of the communication path between the WTRU 410 and the server 430. For example, end-to-end performance evaluation may include evaluating a complete connection, which may include a plurality of connection paths, between the WTRU 410 and the server 430 using a transport protocol, such as TCP or UDP. For simplicity, the end-to-end performance measurement method shown in FIGS. 4-9 may be referred to as connection ECHO.

A WTRU 410 may include a mobility unit 412, such as a MIH function (MIHF) or MIH client, and one or more interfaces 414, 416, 418. Each interface 414, 416, 418 may, for example, be configured to communicate using a different RAT, such as 802.11, Bluetooth, or UMTS. The WTRU 410 may conduct a communication session with a network element 430, such as an inter-RAT mobility server, which may include a mobility unit 432, such as an MIHF or MIH server, and one or more interfaces 434, 436, 438. For example, the WTRU 410 may communicate with the server 430 to perform a handover. Although the WTRU 410 and the server 430 are shown with three interfaces each, any number of interfaces may be used. Although the network element 430 is described as a MIH server, and the connection ECHO method is described as a MIH ECHO method for simplicity; the method and apparatus described herein may be used for any communication session or network element.

The WTRU 410 may exchange capability information, including connection ECHO capability information, with the network element 430. For example, the WTRU 410, the network element 430, or both may indicate support for a connection ECHO method by sending a message, such as a MIH Capability Discover request/response message, including a list of supported methods, such as a MIH_CMD_LIST bitmap, that indicates support for a connection ECHO method. Table 1 shows an example of a list of supported methods and commands, including an indication of support for a connection ECHO method.

TABLE 1

| | | |
|---|---|---|
| MIH_CMD_LIST | Bitmap(32) | MIH commands |
| | | Bitmap values: |

| | |
|---|---|
| Bit #0: | MIH_Link_Get_Parameters |
| Bit #1: | MIH_Link_Configure_Thresholds |
| Bit #2: | MIH_Link_Actions |
| Bit #3: | MIH_Net_HO_Candidate_Query |
| | MIH_Net_HO_Commit |
| | MIH_N2N_HO_Query_Resources |
| | MIH_N2N_HO_Complete |
| | MIH_N2N_HO_Commit |
| Bit #4: | MIH_MN_HO_Candidate_Query |
| | MIH_MN_HO_Commit |
| | MIH_MN_HO_Complete |
| Bit #5: | MIH_Link_Echo |
| Bit #6-30: | Reserved |

The source, which may be the WTRU 410 or the network element 430, may send a connection ECHO request to the target, which may be the network element 430 or the WTRU 410, respectively. The target may receive the connection ECHO request and may send a connection ECHO response to the source. For example, the connection ECHO request message and the connection ECHO response message may be sent using a transport protocol, such as UDP or TCP. The WTRU 410 and the network element 430 may repeat the connection ECHO request, connection ECHO response exchange multiple times to determine end-to-end path quality.

The WTRU 410, or the network element 430, may perform the connection ECHO message exchange on multiple connections and may compare the performance of each connection against each other connection, for example, to optimize connection performance or to load balance connections. Optionally, multiple connection ECHO messages (iterations) may be sent substantially simultaneously on a single connection, or on multiple connections. The performance of a connection may be evaluated, for example, based on round trip time (RTT), sequence number, packet loss ratio, or a combination thereof. The size of the connection ECHO request message may be changed among iterations, and the performance may be evaluated based on the message size.

Optionally, the WTRU 410, or the network element 430, may perform the connection ECHO method on a subset of the available connections, for example, to handover when a current connection is failing (fallback). For example, the WTRU 410 may be performing a communication session with the network element 430 using a first connection. The performance of the first connection may degrade or pass below a threshold, and the WTRU 410, or the network element 430, may initiate a connection ECHO method on one or more other connections to determine which network to use for a handover. In another example, the WTRU 410, or the network element 430, may initiate a connection ECHO method on a current connection to validate that the current connection meets performance requirements.

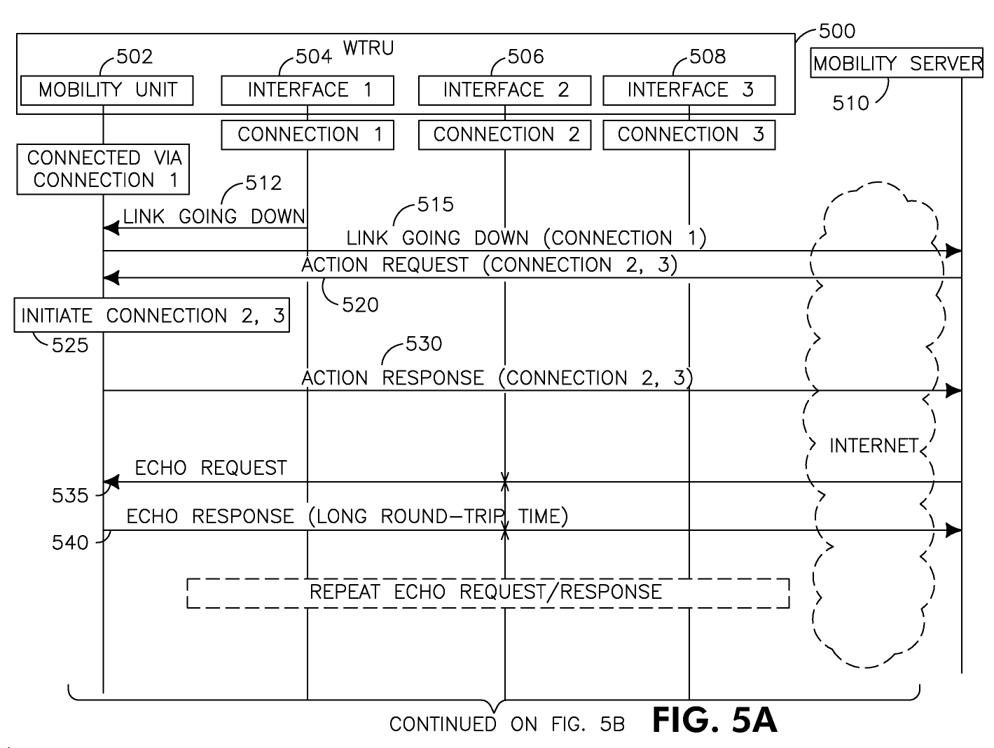

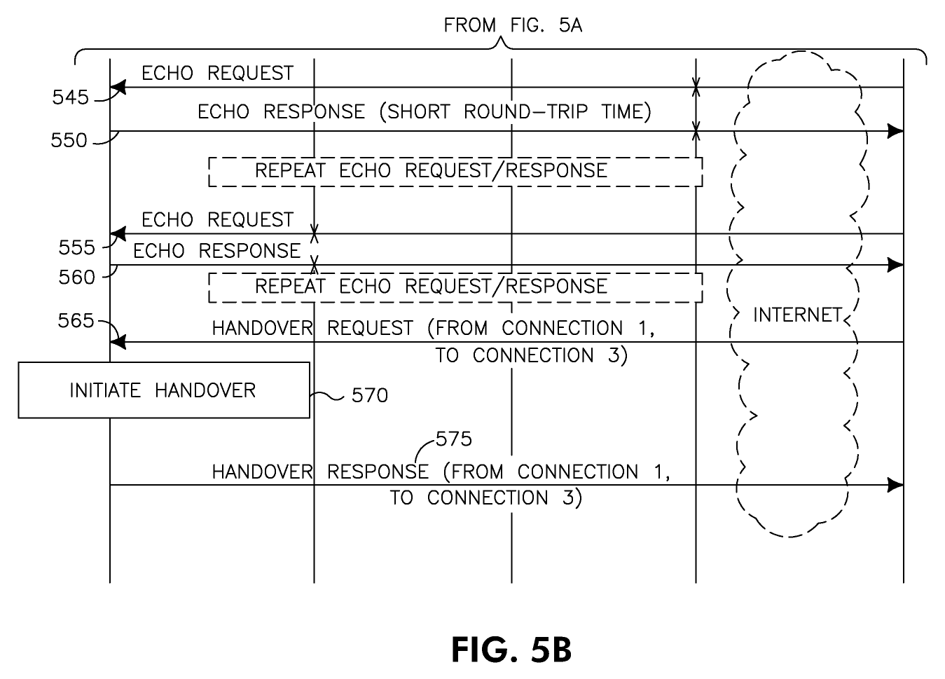

FIGS. 5A-5B show a diagram of an example of a connection ECHO method for inter-RAT fallback. A WTRU 500, including a mobility unit 502 and multiple interfaces 504, 506, 508, may be performing a communication session with a network element 510, such as a mobility server, for example a MIH server, via a first connection using a first interface 504. The WTRU 500 may receive an indication, such as a LinkGoingDown indication, from the first interface indicating that the first connection performance is degrading or has passed below a threshold (512). The WTRU 500 may send a message, such as a LinkGoingDown indication, to the mobility server 510 indicating that the first connection is failing (515).

The mobility server 510 may receive the LinkGoingDown indication and may send a request, such as an Action request, to the WTRU 500 to initiate one or more new connections for performance validation (520). Table 2 shows an example of a list of Action Identifier (AID) messages, including a connection ECHO AID, which may indicate a requested action, such as performance validation.

TABLE 2

| | |
|---|---|
| MIH Messages | AID |

MIH messages for Service Management

| | |
|---|---|
| MIH_Capability_Discover | 1 |
| MIH_Register | 2 |
| MIH_DeRegister | 3 |
| MIH_Event_Subscribe | 4 |
| MIH_Event_Unsubscribe | 5 |

MIH messages for Event Service

| | |
|---|---|
| MIH_Link_Detected | 1 |
| MIH_Link_Up | 2 |
| MIH_Link_Down | 3 |
| MIH_Link_Parameters_Report | 5 |
| MIH_Link_Going_Down | 6 |
| MIH_Link_Handover_Imminent | 7 |
| MIH_Link_Handover_Complete | 8 |

MIH messages for Command Service

| | |
|---|---|
| MIH_Link_Get_Parameters | 1 |
| MIH_Link_Configure_Thresholds | 2 |
| MIH_Link_Actions | 3 |
| MIH_Net_HO_Candidate_Query | 4 |
| MIH_MN_HO_Candidate_Query | 5 |
| MIH_N2N_HO_Query_Resources | 6 |
| MIH_MN_HO_Commit | 7 |
| MIH_Net_HO_Commit | 8 |
| MIH_N2N_HO_Commit | 9 |
| MIH_MN_HO_Complete | 10 |
| MIH_N2N_HO_Complete | 11 |
| MIH_Link_Echo | 12 |

MIH messages for Information Service

| | |
|---|---|
| MIH_Get_Information | 1 |
| MIH_Push_Information | 2 |

The WTRU 500 may receive the request and may initiate the requested connections, such as connection 2 and connection 3 (525). The WTRU 500 may send a message, such as an Action response, to the mobility server 510 indicating that the request connections are ready for link quality validation (530).

The mobility server 510 may evaluate the performance of connection 2. The mobility server 510 may send a connection ECHO request to the WTRU 500 using connection 2 (535). Table 3 shows an example of a format for the connection ECHO request message.

TABLE 3
HEADER
MIH Header Fixed Fields (SID = 3, Opcode = 1, AID = 12)
Source Identifier = sending MIHF ID (MIH server) (TLV type = 1)
Destination Identifier = receiving MIHF ID (MIH client) (TLV type = 2)
PAYLOAD

| IE | DESCRIPTION |
|---|---|
| LinkType TLV | This parameter contains the link |
| (TYPE = 4) | type over which the ECHO message |
| | will be/has been sent |
| ValidTimeInterval TLV | Timestamp filled when sending the |
| (TYPE = 12) | message |
| SequenceNumber TLV | Sequence number. Increased by 1 |
| (TYPE = 64) | for each new echo message request |
| | sent |
| Data TLV | Data to be copied in the response |
| (TYPE = 65) | message. Alphabetical string |

The WTRU 500 may send a connection ECHO response to the mobility server 510 using connection 2 (540). Optionally, the connection ECHO request and connection ECHO response message exchange may be performed multiple times. Table 4 shows an example of a format of a connection ECHO response message.

TABLE 4
HEADER
MIH Header Fixed Fields (SID = 3, Opcode = 2, AID = 12)
Source Identifier = sending MIHF ID (MIH server) (TLV type = 1)
Destination Identifier = receiving MIHF ID (MIH client) (TLV type = 2)
PAYLOAD

| IE | DESCRIPTION |
|---|---|
| LinkType TLV | This parameter contains the link |
| (TYPE = 4) | type over which the echo message |
| | has been sent. The echo response |
| | message must be sent on the same |
| | link as the echo request message |
| | has been received. |
| | Copied from the echo request message |
| ValidTimeInterval TLV | Copied from the echo request message |
| (TYPE = 12) | |
| SequenceNumber TLV | Copied from the echo request message |
| (TYPE = 64) | |
| Data TLV | Copied from the echo request message |
| (TYPE = 65) | |

Referring back to FIGS. 5A-5B, the mobility server 510 may evaluate the performance of connection 3. The mobility server 510 may send a connection ECHO request to the WTRU 500 using connection 3 (545). The WTRU 500 may send a connection ECHO response to the mobility server 510 using connection 3 (550). Optionally, the connection ECHO request and connection ECHO response message exchange may be performed multiple times.

Optionally, the mobility server 510 may evaluate the performance of connection 1. The mobility server 510 may send a connection ECHO request to the WTRU 500 using connection 1 (555). The WTRU 500 may send a connection ECHO response to the mobility server 510 using connection 1 (560). Optionally, the connection ECHO request and connection ECHO response message exchange may be performed multiple times. Although shown separately for simplicity, the connections may be evaluated in any order, or substantially simultaneously.

The mobility server 510 may evaluate the performance of the connections, may select a connection, such as connection 3, for handover and may send a message, such as a Handover request, indicating the selected connection to the WTRU 500 (565). The WTRU 500 may receive the handover request message, may initiate the handover (570). The WTRU 500 may terminate connection 1 and connection 2, and may send a message, such as a Handover response to the mobility server 510 indicating that the handover is complete (575).

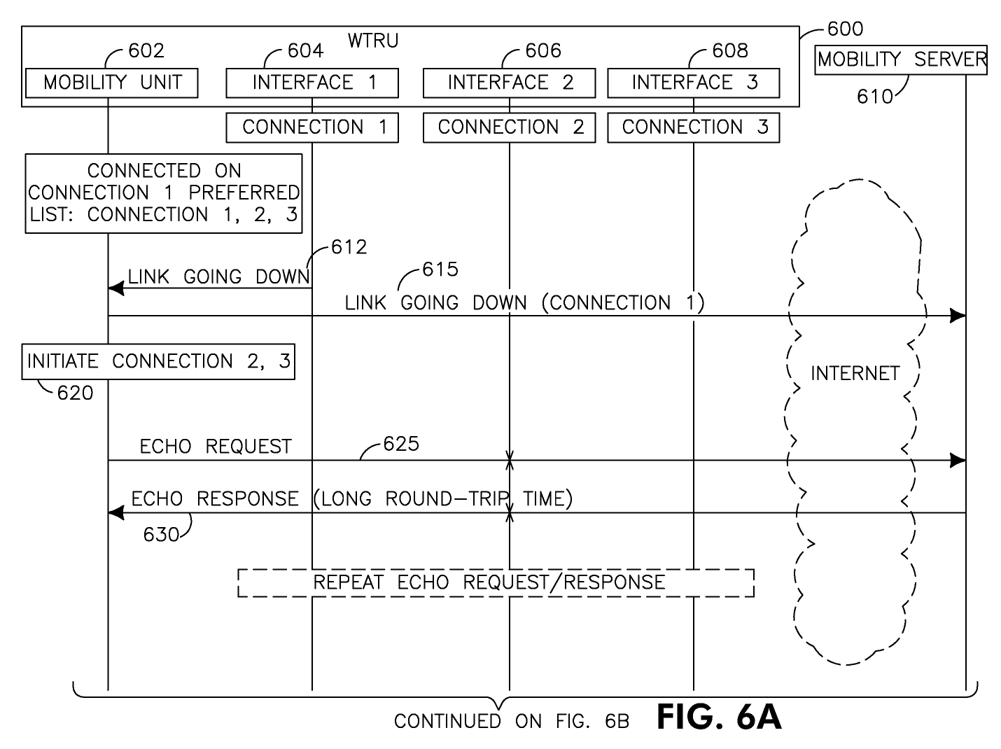

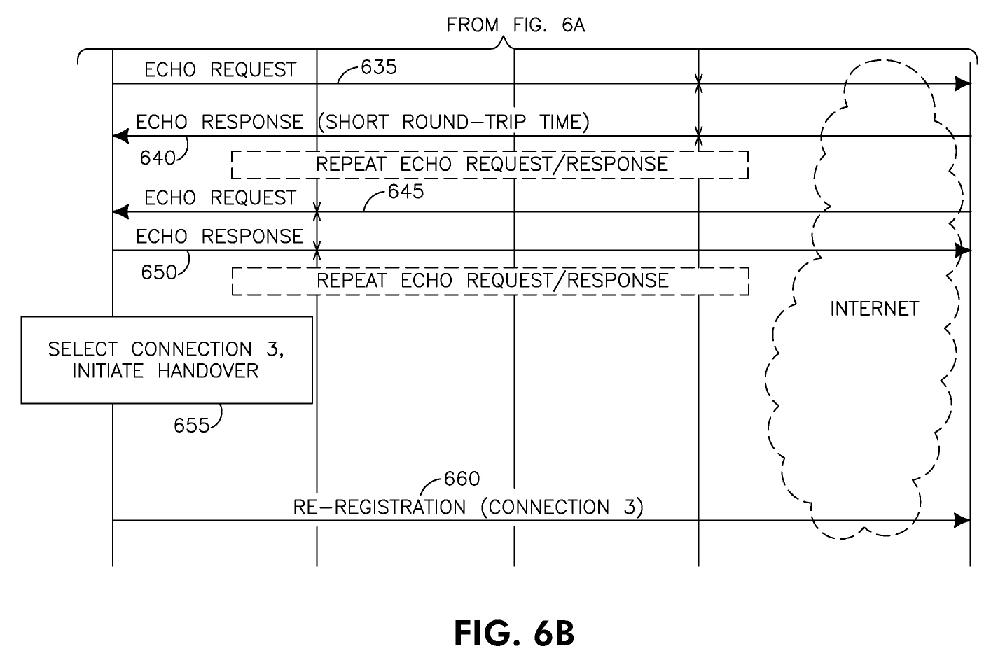

FIGS. 6A-6B show a diagram of an example of a connection ECHO method for standalone fallback. A WTRU 600, including a mobility unit 602 and multiple interfaces 604, 606, 608, may be performing a communication session with a mobility server 610, such as a mobility server, for example a MIH server, via a first connection using a first interface 604. The WTRU 600 may also include a list of connection preferences. The WTRU 600 may receive an indication, such as a LinkGoingDown indication, from the first interface 604 indicating that the first connection performance is degrading or has passed below a threshold (612). The WTRU 600 may send a message, such as a LinkGoingDown indication, to the mobility server 610 indicating that the first connection is failing (615).

The WTRU 600 may initiate the one or more other connections, such as connection 2 and connection 3 (620). For example, the WTRU 600 may initiate one or more connections from the list of preferred connections. The WTRU 600 may evaluate the performance of connection 2. The WTRU 600 may send a connection ECHO request to the mobility server 610 using connection 2 (625). The mobility server 610 may send a connection ECHO response to the WTRU 600 using connection 2 (630). Optionally, the connection ECHO request and connection ECHO response message exchange may be performed multiple times.

Similarly the WTRU 600 may evaluate the performance of connection 3. The WTRU 600 may send a connection ECHO request to the mobility server 610 using connection 3 (635). The mobility server 610 may send a connection ECHO response to the WTRU 600 using connection 3 (640). Optionally, the connection ECHO request and connection ECHO response message exchange may be performed multiple times.

Optionally, the WTRU may evaluate the performance of connection 1. The WTRU may send a connection ECHO request to the network element using connection 1 (645). The network element may send a connection ECHO response to the WTRU using connection 1 (650). Optionally, the connection ECHO request and connection ECHO response message exchange may be performed multiple times. Although shown separately for simplicity, the connections may be evaluated in any order, or substantially simultaneously.

The WTRU 600 may evaluate the performance of the connections, may select a connection, such as connection 3, for handover and may initiate the handover (655). The WTRU 600 may terminate connection 1 and connection 2, and may send a message, such as a re-registration message, to the mobility server 610 indicating that the handover is complete (660).

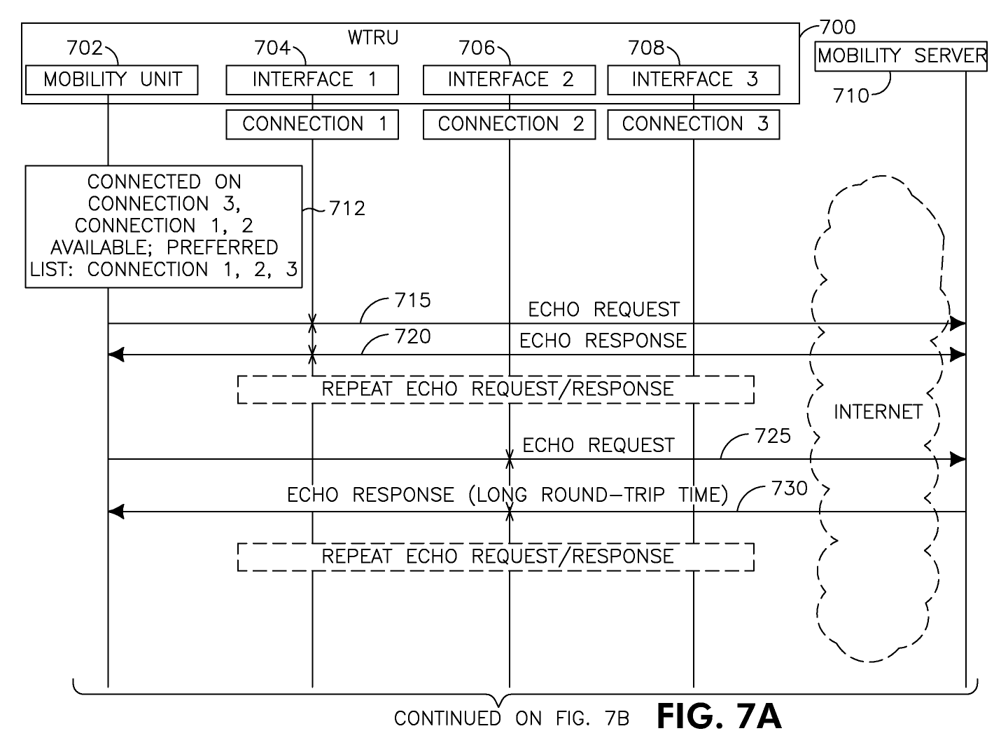

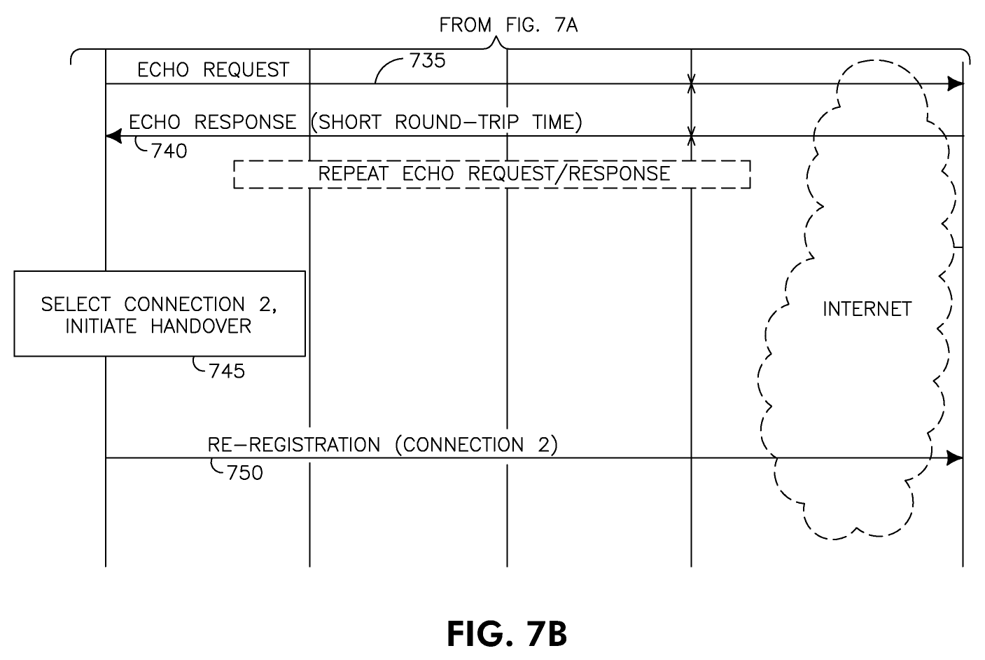

FIGS. 7A-7B show a diagram of an example of a connection ECHO method for standalone optimization. A WTRU 700, including a mobility unit 702 and one or more interfaces 704, 706, 708, may evaluate performance of one or more available connections for performing a communication session with a network element 710, such as a mobility server, for example a MIH server. Optionally, one or more of the connections may be in use for the communication session. The WTRU 700 may also include a list of connection preferences.

The WTRU 700 may initiate one or more of the available connections (712). Optionally, the connections initiated may be based on the list of connection preferences. The WTRU 700 may evaluate the performance of connection 1. The WTRU 700 may send a connection ECHO request to the mobility server 710 using connection 1 (715). The mobility server 710 may send a connection ECHO response to the WTRU 700 using connection 1 (720). Optionally, the connection ECHO request and connection ECHO response message exchange may be performed multiple times. The WTRU 700 may evaluate the performance of connection 2. The WTRU 700 may send a connection ECHO request to the mobility server 710 using connection 2 (725). The mobility server 710 may send a connection ECHO response to the WTRU 700 using connection 2 (730). Optionally, the connection ECHO request and connection ECHO response message exchange may be performed multiple times.

Optionally, the WTRU 700 may evaluate the performance of a current connection, such as connection 3. The WTRU 700 may send a connection ECHO request to the mobility server 710 using connection 3 (735). The mobility server 710 may send a connection ECHO response to the WTRU 700 using connection 1 (740). Optionally, the connection ECHO request and connection ECHO response message exchange may be performed multiple times. Although shown separately for simplicity, the connections may be evaluated in any order, or substantially simultaneously.

The WTRU 700 may evaluate the performance of the connections, may select a connection, such as connection 1, for handover and may initiate the handover (745). The WTRU 700 may terminate connection 2 and connection 3, and may send a message, such as a re-registration message, to the mobility server 710 indicating that the handover is complete (750).

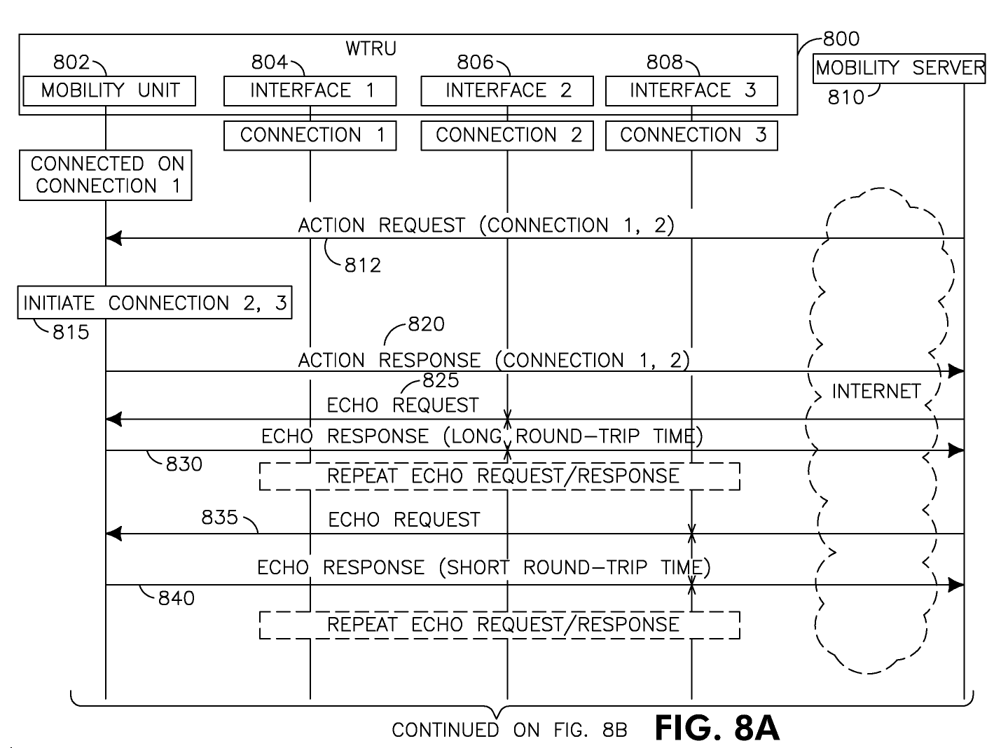

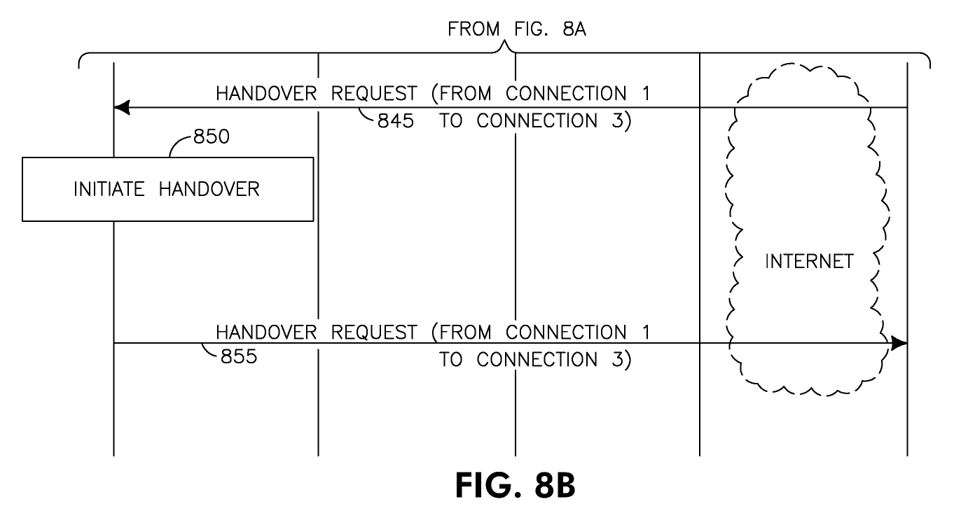

FIGS. 8A-8B show a diagram of an example of a connection ECHO method for load-balancing. A WTRU 800, including a mobility unit 802 and multiple interfaces 804, 806, 808, may be performing a communication session with a network element 810, such as a mobility server, for example a MIH server, via a first connection (connection 1) using a first interface 804. The mobility server 810 may send a request, such as an Action request, to the WTRU 800 to initiate one or more new connections for performance validation (812). The WTRU 800 may receive the request and may initiate the requested connections, such as connection 2 and connection 3 (815). The WTRU 800 may send a message, such as an Action response, to the mobility server 810 indicating that the request connections are ready for link quality validation (820).

The mobility server 810 may evaluate the performance of connection 2. The mobility server 810 may send a connection ECHO request to the WTRU 800 using connection 2 (825). The WTRU 800 may send a connection ECHO response to the mobility server 810 using connection 2 (830). Optionally, the connection ECHO request and connection ECHO response message exchange may be performed multiple times.

Similarly the mobility server 810 may evaluate the performance of connection 3. The mobility server 810 may send a connection ECHO request to the WTRU 800 using connection 3 (835). The WTRU 800 may send a connection ECHO response to the mobility server 810 using connection 3 (840). Optionally, the connection ECHO request and connection ECHO response message exchange may be performed multiple times.

The mobility server 810 may evaluate the performance of the connections, may select a connection, such as connection 3, for handover, and may send a message, such as a Handover request, to the WTRU 800 (845). The WTRU 800 may receive the handover request message, and may initiate the handover (850). The WTRU 800 may terminate connection 1 and connection 2, and may send a message, such as a Handover response to the mobility server 810 indicating that the handover is complete (855).

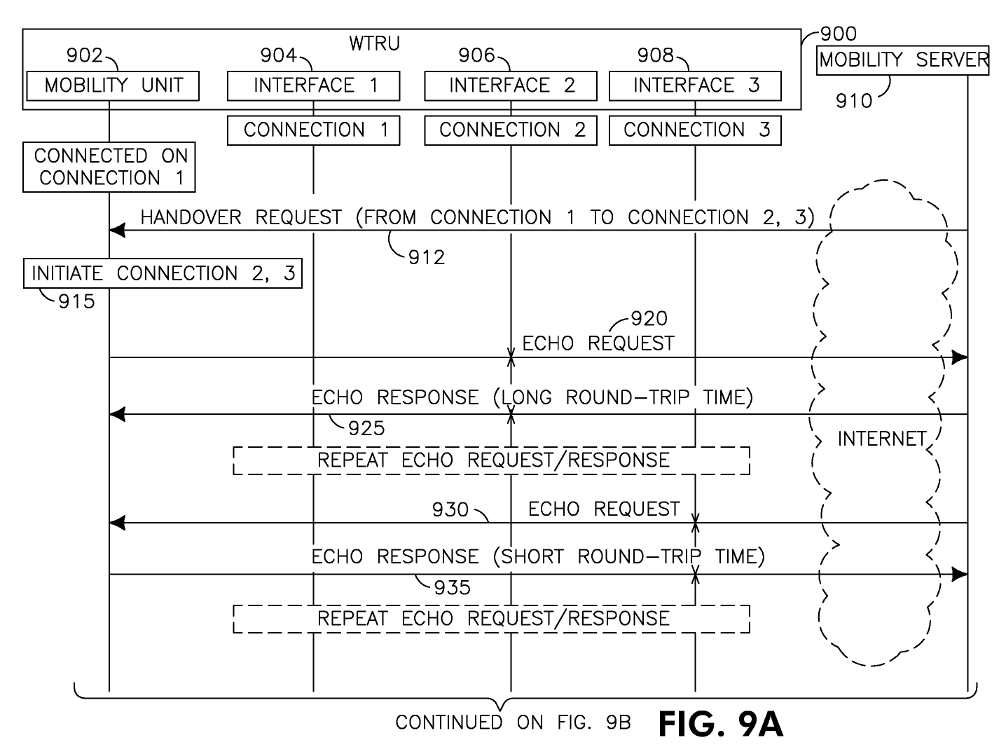

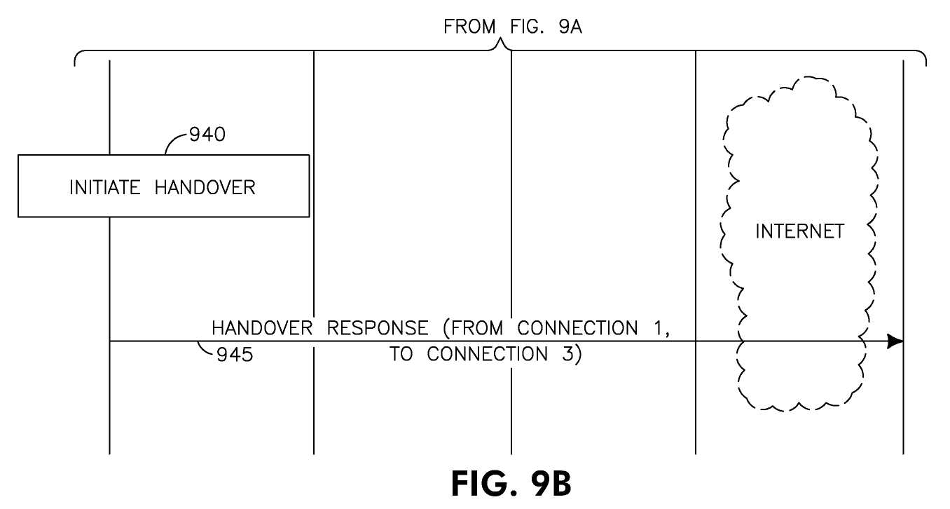

FIGS. 9A-9B show a diagram of an example of a connection ECHO method for standalone load-balancing. A WTRU 900, including a mobility unit 902 and multiple interfaces 904, 906, 908, may be performing a communication session with a network element 910, such as a mobility server, for example a MIH server, via a first connection (connection 1) using a first interface 904. The mobility server 910 may send a request, such as a handover request, to the WTRU 900 to initiate a handover to one or more different connections, such as connection 2 or connection 3 (912). The WTRU 900 may receive the request and may initiate the requested connections (915).

The WTRU 900 may evaluate the performance of connection 2. The WTRU 900 may send a connection ECHO request to the mobility server 910 using connection 2 (920). The mobility server 910 may send a connection ECHO response to the WTRU 900 using connection 2 (925). Optionally, the connection ECHO request and connection ECHO response message exchange may be performed multiple times.

Similarly, the WTRU 900 may evaluate the performance of connection 3. The WTRU 900 may send a connection ECHO request to the mobility server 910 using connection 3 (930). The mobility server 910 may send a connection ECHO response to the WTRU 900 using connection 3 (935). Optionally, the connection ECHO request and connection ECHO response message exchange may be performed multiple times.

The WTRU 900 may evaluate the performance of the connections and may select a connection, such as connection 3, for handover (940). The WTRU 900 may initiate the handover, terminate connection 1 and connection 2, and may send a message, such as a Handover response to the mobility server 910 indicating that the handover is complete (945).

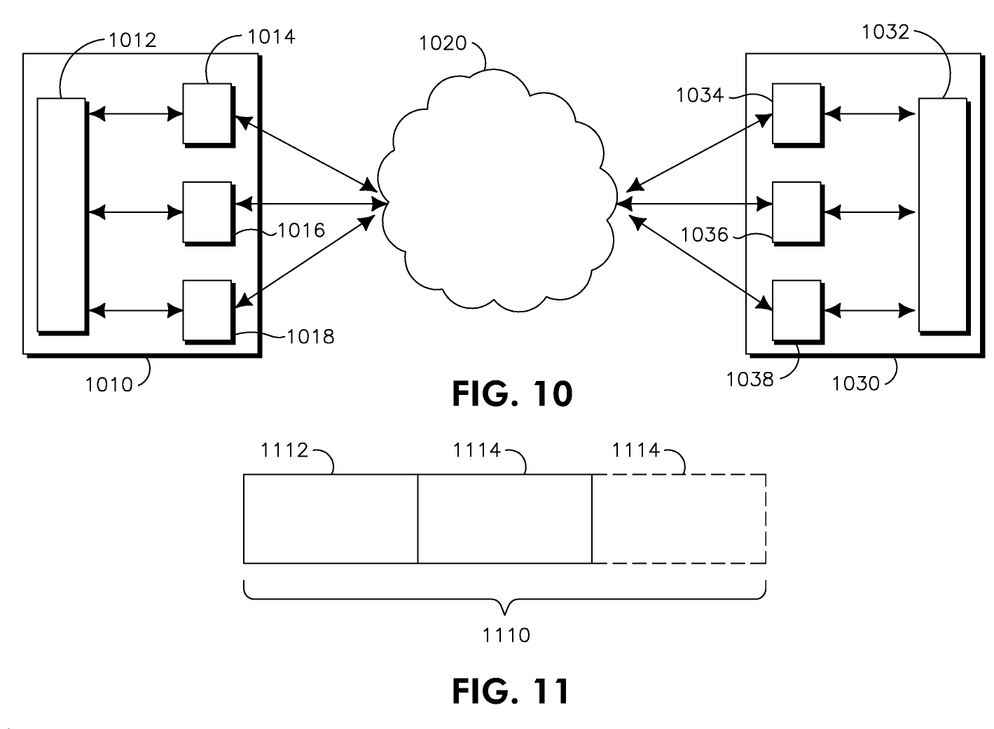

FIG. 10 shows an example of a method of multihoming. Multihoming may include a WTRU performing a communication session using a plurality of substantially concurrent connections. A WTRU 1010 may include a mobility unit 1012, such as a MIH function (MIHF) or MIH client, and one or more interfaces 1014, 1016, 1018. Each mobility unit 1012, 1032 may include a multihoming unit which may perform the communication session using one or more connections. Each interface 1014, 1016, or 1018 may be configured to communicate using a different connection.

The WTRU 1010 may perform a communication session with a network element 1030, such as an inter-technology mobility server, which may include a mobility unit 1032, such as an MIHF or MIH server, and one or more interfaces 1034, 1036, 1038. For example, the WTRU 1010 may be communicating with the server 1030 to perform a handover. Although the WTRU 1010 and the server 1030 are shown with three interfaces each, it should be apparent that any number of interfaces may be used. Each mobility unit 1012, 1032 may be identified by an identifier (ID), such as a MIHF ID. For example, the ID may be a Network Access Identifier (NAI).

The multihoming unit may manage the flow of messages across multiple connections. Message flow management may be based on, for example, preference, performance metrics, message type, network policy, or a combination thereof. For example, the WTRU 1010 may perform the communication using a first connection that includes a UMTS interface, and a second connection that includes an 802.11 interface. The multihoming unit may evaluate the performance of the interfaces, for example, using the ECHO method shown in FIGS. 4-9, and may send a message using the interface exhibiting better performance metrics. In another example, the multihoming unit may send a Command Service (CS) message or an Event Service (ES) message using a first interface, and may send an Information Service (IS) message using a second interface. In another example, the multihoming unit may include list of interface preferences, and may send a message using a preferred and available interface. The preferences may be user generated, or may be generated by a network element, such as the server 1030.

A change in the multihoming configuration, including a change from a single connection to multiple connections, may be initiated by the WTRU 1010 or the server 1030. For example, either the WTRU 1010 or the server 1030 may detect that the quality of a connection is degrading or has fallen below a threshold. The quality of a connection may be determined based on, for example, the ECHO method shown in FIGS. 4-9, or any other method capable of indicating the quality of a connection. A lost message, or the need for retransmission of a message, may also indicate that the quality of a connection is degrading or has fallen below a threshold. A change in the multihoming configuration may also be initiated in response to the establishment of a new connection or based on the activation of an interface 1014-1018, 1034-1038. Optionally, the WTRU 1010 may initiate a change in the multihoming configuration in response to a message received from the server 1030, or from another network element.

FIG. 11 shows a diagram of an example of a structure of a multihoming identifier. The multihoming identifier (MHID) 1110 may include a device identifier (ID) 1112, such as a MIH Node ID. The MHID may also include an interface ID 1114, such as a local adaptor address, and IP address, or any other address capable of identifying the interface. Although shown as including two elements, the device ID 1112 and the interface ID 1114, the MHID 1110 may include any number of elements. For example, the MHID 1110 may include the device ID 1112, an IP address, and a network adaptor address. The MHID 110 may be updated dynamically.

The device ID 1112 may be assigned during connection establishment, for example, during registration. A network element, such as the server shown in FIG. 10, may maintain a list of device IDs associated with a plurality of WTRUs. Adding an interface to a multihoming configuration may include adding an interface ID 1114 to an existing MHID 1110, and removing an interface from the multihoming configuration may include deleting the interface ID 1114. For example, a WTRU may remove an interface from the multihoming configuration and may send a message to the server indicating that the interface ID 1114 is no longer valid. The server may remove the corresponding interface ID 1114 from the MHID 1110.

Alternatively, a link identifier that is associated with a transport link of a MIH message may be added to the MIH message. For example, a message, such as a MIH Link Going Down indication, may include a first link identifier, such as a LinkIdentifier Information Element (IE), that indicates a degrading link between the mobility unit in the WTRU and the mobility unit in the server, and a second link identifier, which may be a LinkIdentifier IE, associated with the link transporting the MIH message. Although the link identifier is described in terms of a LinkIdentifier IE, any IE or message that can indicate the transport link may be used.

A MHID or link identifier, as described herein, may be used for flow mobility. For example, a network element, such as a MIH server, may send a message, such as a handover (HO) command, that indicates one or more connections to a WTRU. The WTRU may then handover a communication session to the indicated connections.

For example, the multihoming configuration may include two connections and the WTRU may send a message using both connections. Optionally, the WTRU may send a message on a first connection, such as an uplink (UL) connection or a bi-directional connection, and may receive a message on a second connection, such as a downlink (DL) connection or a bi-directional connection. The multihoming configuration may be optimized, for example, for load balancing or reliability. Although two connections are described for simplicity, any number of connections may be used.

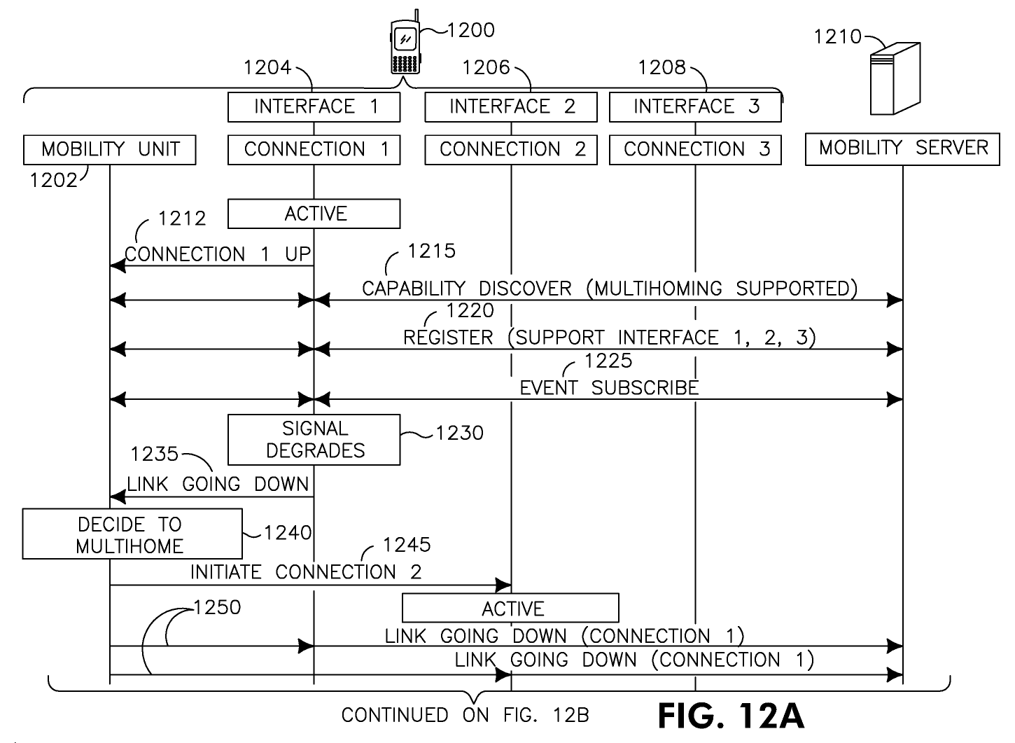

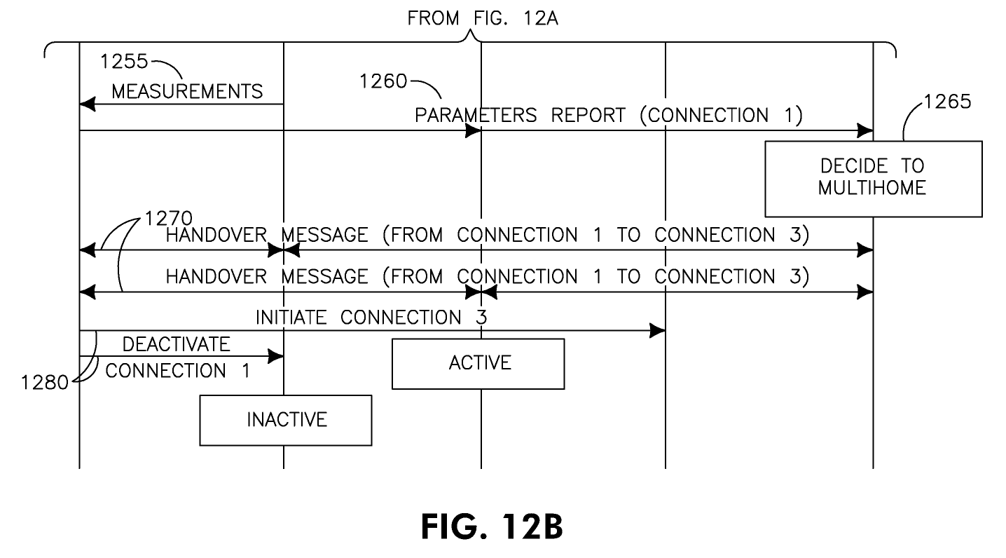

FIGS. 12A-12B show a diagram of a method of a multihoming configuration optimized for reliability. A WTRU 1200 may be configured with a mobility unit (MUw) 1202, and, one or more interfaces 1204, 1206, 1208. Similarly, a network element 1210, such as a mobility server, for example, a MIH server, may be configured with a mobility unit (MUs) and one or more interfaces. For simplicity, the mobility unit ant the interfaces at the mobility server 1210 are not shown.

The WTRU 1210 may initiate a first connection (Connection 1) using a first interface 1204 (1210). The MUw 1202 may exchange capability information, such as multihoming capability information, with the mobility server 1210 via the first connection, using, for example, a mobility capability discovery message (1215). The MUw 1202 may register with the server via the first connection using, for example, a mobility registration message that indicates the supported interfaces 1204, 1206, 1208 (1220). The MUw 1202, the mobility server 1210, or both may subscribe to an event using, for example, an event subscribe message that indicates an event for which corresponding notification messages are requested (1225). For example, the MUw 1202 may subscribe to a measurements event, and may receive measurement report notifications as shown.

The WTRU 1200 may detect that the signal strength, or other performance metric, of the first connection is dropping or has fallen below a threshold (1230). For example, the WTRU 1200 may perform an ECHO method as shown in FIGS. 4-9 on the first connection. Interface 1 1204 may generate a message, such as a MIH Link Going Down indication, indicating the change in performance of the first connection and may send the message to the MUw 1202 (1235). The MUw 1202 may determine that multihoming may be advantageous (1240) and may initiate multihoming via a second connection using a second interface 1206 (1245). Initiating the use of the second connection may be similar to performing a handover.

The MUw 1202 may send the message indicating the change in connection performance of connection 1 to the mobility server 1210 using the first connection, the second connection, or both (1250). Optionally, the WTRU 1200 may make further connection performance measurements (1255). For example, the interfaces 1204, 1206, 1208 may take measurements, such as RSSI for link quality or packet loss rate, and may pass the measurements to the MUw 1202. The MUw 1202 may send a message including connection performance information to the mobility server 1210 using the first connection, the second connection, or both (1260). For example, the MUw 1202 may send the message using the second connection based on, for example, connection performance.

The mobility server 1210 may receive the message indicating the change in connection performance and the message including connection performance information and may evaluate whether to send messages to the WTRU 1200 using the first connection, the second connection, or both (1265). The mobility server 1210 may send a message, such as a handover message, for example a MIH Net HO Commit message, using connection 1, connection 2, or both, to the WTRU 1200 (1270). For example, the handover message may indicate a handover from connection 1 to connection 3.

The WTRU 1200 may receive the handover message via connection 1 and connection 2 and may perform a handover from connection 1 to connection 3. For example, the WTRU 1200 may initiate connection 3 using a third interface 1208, and may terminate connection 1 and deactivate the first interface 1204 (1280).

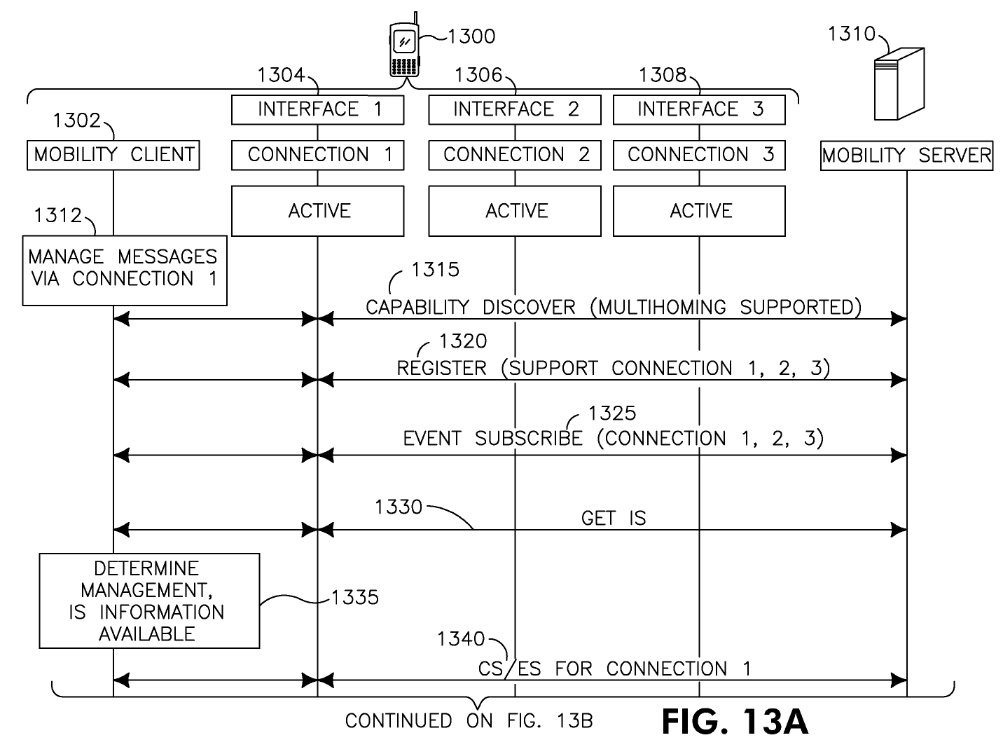

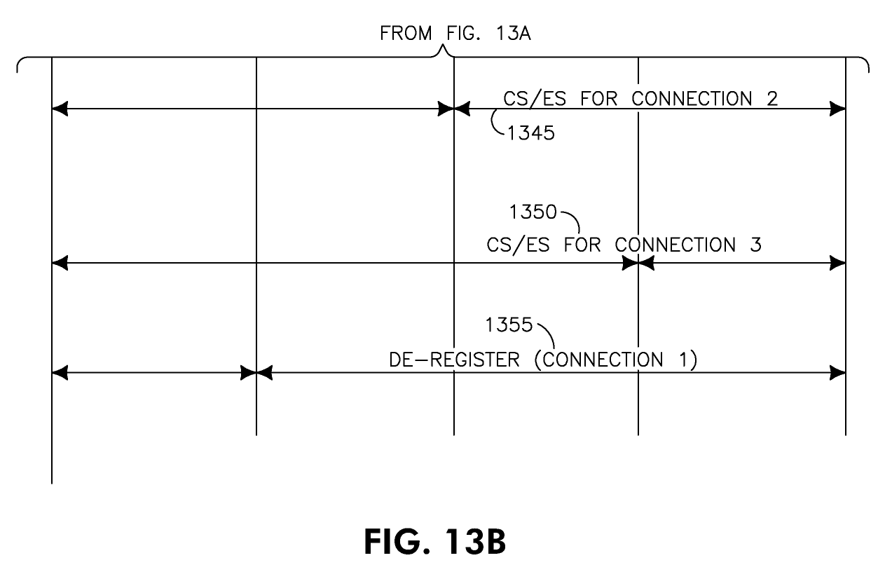

FIGS. 13A-13B show a diagram of an example of a method of multihoming message distribution. A WTRU 1300 may be configured with a mobility unit (MUw) 1302, and, one or more interfaces 1304, 1306, 1308. Similarly, a network element 1310, such as a mobility server, for example an MIH server, may be configured with a mobility unit (MUs) and one or more interfaces. For simplicity, the mobility unit and the interfaces at the mobility server 1310 are not shown. The WTRU 1300 may be communicating via multiple connections. For example, connection 1 may use a first interface 1304, connection 2 may use a second interface 1306, and connection 3 may use a third interface 1308. Although three connections are shown for simplicity, any number of connections may be used.

The MUw 1302 may dedicate a connection, such as connection 1, for communication of a predetermined message type, such as MIH service management messages (1310). For example, the MUw 1302 may determine that connection 1 is reliable or is underutilized. Optionally, the MUw 1302 may also use the dedicated connection for transmitting IS messages, as shown.

The MUw 1302 may exchange capability information, such as multihoming capability information, including information about connection 1, connection 2, connection 3, or any combination thereof, with the mobility server 1310 via the first connection, using, for example, a mobility capability discovery message (1315). The MUw 1302 may register with the server via the first connection using, for example, a mobility registration message that indicates the interfaces 1304, 1306, 1308 (1320). The registration may include transmitting information about connection 1, connection 2, connection 3, or any combination thereof. The MUw 1302, the mobility server 1310, or both may subscribe to an event using, for example, an event subscribe message that indicates an event for which corresponding notification messages are requested (1325). The WTRU 1300 may receive an IS message, including information about connection 1, connection 2, connection 3, or any combination thereof, via connection 1 using the first interface 1304 (1330).

The WTRU 1300 may determine that information regarding Control Services (CS), Event Service (ES), or both, is available (1335). The WTRU 1300 may receive information regarding CS, ES, or both for connection 1 via connection 1 (1340). The WTRU 1300 may receive information regarding CS, ES, or both for connection 2 via connection 2 (1345). The WTRU 1300 may receive information regarding CS, ES, or both for connection 3 via connection 3 (1350). Although the WTRU 1300 is shown receiving information regarding a particular connection via that connection, information regarding any connection may be received on any connection, or combination of connections. The WTRU 1300 may send a message to de-register the connections using connection 1 (1355).

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (WTRU), terminal, base station, Mobility Management Entity (MME) or Evolved Packet Core (EPC), or any host computer. The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

What is claimed is:

1. A method for use in wireless communication, the method comprising: generating a connection performance metric for a connection by:
transmitting a connection ECHO request message,
receiving a connection ECHO response message, and
comparing the ECHO request message with the ECHO response message; and
evaluating the connection performance metric.

2. The method of claim 1, wherein the transmitting includes sending a plurality of ECHO request messages and the receiving includes receiving a plurality of ECHO response messages.

3. The method of claim 2, wherein each ECHO request message in the plurality of ECHO request messages is a different size.

4. The method of claim 2, wherein the connection includes a plurality of connections, the sending a plurality of ECHO request messages includes sending an ECHO request message on each of the plurality of connections, and the receiving a plurality of ECHO response messages includes receiving an ECHO response message on each of the plurality of connections.

5. The method of claim 1, wherein the generating a connection performance metric includes producing a connection performance metric for each of a plurality of connections.

6. The method of claim 1, wherein the transmitting includes using Transmission Control Protocol (TCP) or User Datagram Protocol (UDP).

7. The method of claim 1, wherein the evaluating includes determining whether to perform a media independent handover (MIH).

8. The method of claim 1, wherein the evaluating includes determining whether to modify a multihoming configuration.

9. The method of claim 1, further comprising:
modifying a communication session connection configuration by performing a handover, establishing a connection, or deactivating a connection.

10. A method for use in a wireless transmit/receive unit, the method comprising:
performing a multihoming communication session with a mobility server by communicating with the mobility server via a plurality of concurrent connections.

11. The method of claim 10, wherein the communicating with the mobility server via a plurality of concurrent connections includes transmitting a message to the mobility server using a first connection selected from the plurality of concurrent connections and a second connection selected from the plurality of concurrent connections.

12. The method of claim 10, wherein the communicating with the mobility server via a plurality of concurrent connections includes receiving a message from the mobility server using a first connection selected from the plurality of concurrent connections and a second connection selected from the plurality of concurrent connections.

13. The method of claim 10 wherein the plurality of concurrent connections includes a connection using each of a plurality of radio access technologies.

14. The method of claim 10 wherein each connection in the plurality of concurrent connections is associated with a unique Internet Protocol (IP) address.

15. The method of claim 14 wherein the plurality of concurrent connections includes a plurality of links.

16. The method of claim 10, wherein the mobility server is a Media Independent Handover (MIH) server.

17. The method of claim 10, further comprising:
modifying a configuration of the multihoming communication session by adding a connection to the plurality of concurrent connections or removing a connection from the plurality of concurrent connections.
